(19) United States
(12) Patent Application Publication
(10) Pub. No.: US 2025/0133425 A1
(43) Pub. Date: Apr. 24, 2025

(54) CELLULAR SITE PERFORMANCE ISSUE DETECTION AND CORRELATION

(71) Applicant: DISH Wireless L.L.C., Englewood, CO (US)

(72) Inventors: John Sabando, Aurora, CO (US); Calvin Chen, Englewood, CO (US); Matthew Porter, Plainville, GA (US); Arnold Agcaoili, Littleton, CO (US)

(21) Appl. No.: 18/907,276

(22) Filed: Oct. 4, 2024

Related U.S. Application Data
(60) Provisional application No. 63/544,922, filed on Oct. 19, 2023.

(51) Int. Cl. H04W 16/18; H04W 24/10

(52) U.S. Cl. CPC H04W 24/04

(57) ABSTRACT

A system receives the log messages including data regarding one or more cell site performance issues of a cell site. Based on the log messages, the system determines whether there is a time-based correlation between a cell site router (CSR) of the cell site experiencing a cold start and the one or more cellular site performance issues. Then, based on the determination whether there is a time-based correlation between the CSR experiencing a cold start and the one or more cell site performance issues, the system electronically generates an action item associated with addressing the one or more cell site performance issues.

### TECHNICAL FIELD

The present disclosure relates generally to wireless cellular telecommunications, more particularly, to cellular (cell) site performance issue detection and correlation.

### BRIEF SUMMARY

In various scenarios in cellular telecommunications networks, there may be cell site performance issues which can be correlated to cell site router (CSR) performance issues. Detecting such cell site performance issues and determining the cause as related to or otherwise correlated with the CSR, as well as identifying particular CSRs of concern across the entire network in order to address the issues with the proper engineering teams and/or CSR vendor may present technical challenges due to the enormous volume of log messages relating to the CSRs.

To solve the above technical problems, disclosed is a system that receives the log messages including data regarding one or more cell site performance issues of a cell site. Based on the log messages, the system determines whether there is a time-based correlation between a CSR of the cell site experiencing a cold start and the one or more cellular site performance issues. Then, based on the determination whether there is a time-based correlation between the CSR experiencing a cold start and the one or more cell site performance issues, the system electronically generates an action item associated with addressing the one or more cell site performance issues.

In an example embodiment the system receives log messages including data regarding one or more cellular (cell) site performance issues for a plurality of cell sites. Based on the log messages, the system determines whether there are time-based correlations between respective cell site routers (CSRs) of the plurality of cell sites experiencing cold starts and the one or more cell site performance issues for the plurality of cell sites. Based on the determination whether there are time-based correlations between respective CSRs of the plurality of cell sites experiencing cold starts and the one or more cellular site performance issues for the plurality of cell sites, the system detects patterns in cell site performance issues that identify particular respective CSRs of the plurality of cell sites that are of specific concern. For example, these patterns may indicate one CSR has a higher frequency of particular types of performance issues than other CSRs. This particular CSR may then be identified as being of specific concern. The system then electronically generates one or more action items associated with addressing performance issues of the particular respective CSRs that are of specific concern.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 is a block diagram illustrating an example portion of a 5G cellular network in which cellular site performance issue detection and correlation may be implemented in accordance with embodiments described herein.

FIG. 2 is an example wiring diagram illustrating various example ports of a CSR and DU in accordance with embodiments described herein.

FIG. 3 illustrates a logical flow diagram showing one embodiment of example process for cellular site performance issue detection and correlation in accordance with embodiments described herein.

FIG. 4 illustrates a logical flow diagram showing at a higher level than in FIG. 3, one embodiment of example process for cellular site performance issue detection and correlation in accordance with embodiments described herein.

FIG. 5 illustrates a logical flow diagram showing one embodiment of example process for cellular site performance issue detection and correlation in instances where the CSR did not experience a cold restart at substantially the same time as a performance event occurred in accordance with embodiments described herein.

FIG. 6 illustrates a logical flow diagram showing one embodiment of example process for cellular site performance issue detection and correlation involving detecting patterns in cell site performance issues that identify particular CSRs that are of specific concern from a plurality of cell sites in accordance with embodiments described herein.

FIG. 7 shows a system diagram that describes an example implementation of an underlying computing system for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

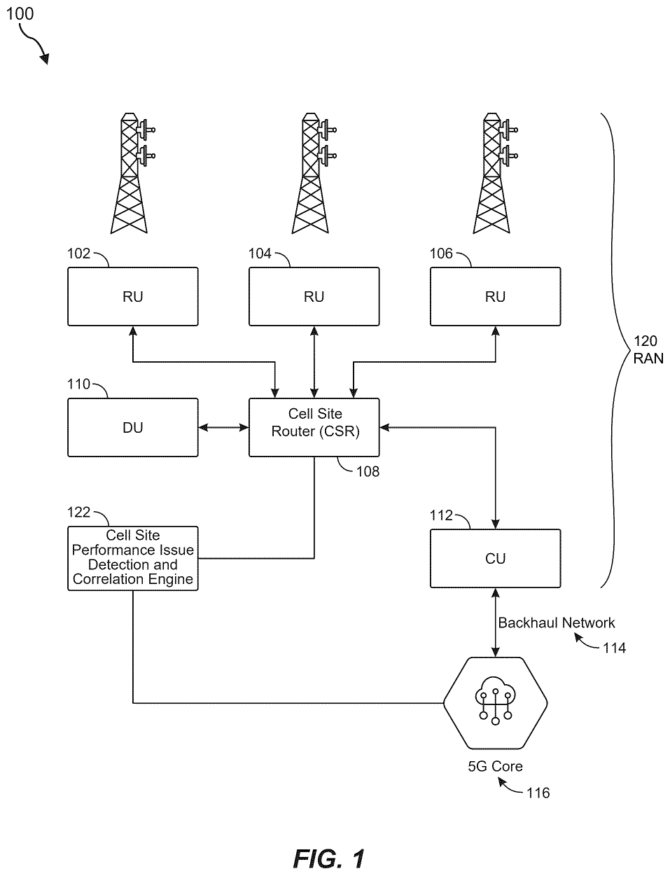

FIG. 1 is a block diagram illustrating an example portion of a 5G cellular network 100 in which cellular site performance issue detection and correlation may be implemented in accordance with embodiments described herein.

The mobile, or cellular/wireless network 100 comprises two domains: the Radio Access Network (RAN) 120 and the Core Network (Core) 116. One of the foundations of the Fifth Generation (5G) architecture is to split the RAN 120 into the Radio Unit (RU) (e.g., RU 102, RU 104 and RU 106), Distributed Unit (DU) 110, and the Centralized Unit (CU) 112, to make network deployments more flexible and scalable. This does away with monolithic end-to-end system vendors and opens the architecture to interoperable best-in-class components. It also enables software-based Network Virtualized Functions (NFV) to handle the specific tasks of the 5G networking, which adds agility and futureproofs the network. The RAN 120 is the final link between the network and the mobile phone or other connected device. It is the visible piece and includes the antennae seen on cellular telecommunications towers, on top of buildings or in stadia, plus the base stations. When a cellular telephone call is made or a connection to a remote server, the antenna transmits and receives signals to and from the cellular telephone phones or other connected devices, e.g., Internet-of-Things (IoT) devices. The signal is then digitalized in the RAN base station and connected into the network.

The Core 116 has many functions. It provides access controls ensuring users are authenticated for the services they are using, it routes telephone calls over the public-switched telephone network, it enables operators to charge for calls and data use, and it connects users to the rest of the world via the Internet. It also controls the network by making handovers happen as a user moves from coverage provided by one RAN tower to the next.

The RUs, such as RU 102, RU 104 and RU 106 of FIG. 1, are located at the cellular telecommunications tower base station and are where the radio frequency signals are transmitted, received, amplified and digitized. Each RU is located near, or integrated into, the antenna of the cellular telecommunications tower. Each cellular telecommunications tower may have multiple RUs to fully service a particular coverage area. The DU 110 and CU 112 are the computation parts of the base station. They receive the digitialized radio signal from the RUs (RU 102, RU 104 and RU 106) via the cellular (cell) site router (CSR) 108 that routes traffic from the RUs (RU 102, RU 104 and RU 106) to the DU 110, and send the digitialized radio signal into the network. The DU 110 is physically located at or near the RU (e.g., RU 102, RU 104 and RU 106) whereas the CU 112 can be located nearer the Core 116. The key concept of Open RAN is “opening” the protocols and interfaces between these various building blocks (radios, hardware and software) in the RAN 120. The O-RAN Alliance has defined at least 11 different interfaces within the RAN including those for: Fronthaul between the RUs (RU 102, RU 104 and RU 106) and the DU 110, Midhaul between the DU 110 and the CU 112 and Backhaul 114 connecting the RAN 120 to the Core 116.

The Cell Site Performance Issue Detection and Correlation Engine 122 may detect performance issues of a cell site including CSR 108 and correlate those with issues with performance issues associated with the CSR 108 as described herein.

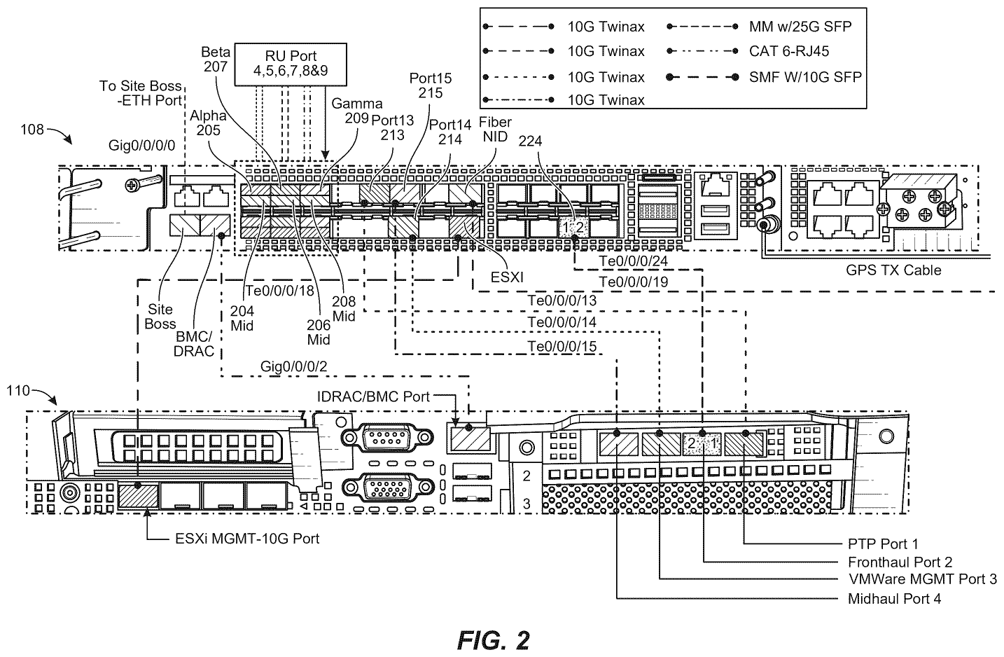

FIG. 2 is an example wiring diagram illustrating various example ports of a CSR 108 and DU 110 in accordance with embodiments described herein. In the example embodiment, Ports 4 204, 5 205, 6 206, 7 207, 8 208 and 9 209 in the CSR 108 are respective RU ports and may be connected as shown represented by dashed lines to ports 13 213, 14 214, 15 215 and 24 224, which are associated with the DU 110. The specific port names and locations may vary in different embodiments.

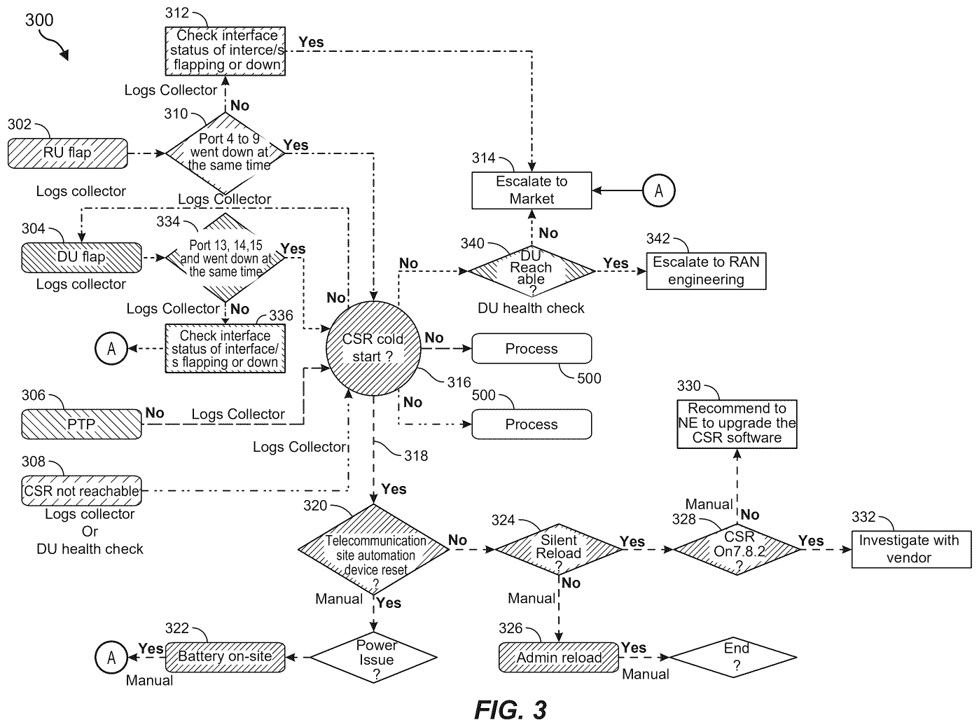

FIG. 3 illustrates a logical flow diagram showing one embodiment of example process 300 for cellular site performance issue detection and correlation in accordance with embodiments described herein.

Various cell site performance issues may occur at a cell site such as that shown in FIG. 1 and be detected via log messages generated, for example, by the CSR 108 for the cell site shown in FIG. 1. Such logs may be collected via monitoring system that includes a logs collector, such as for example, that provided by Vitria®. Such log messages may be received by the Cell Site Performance Issue Detection and Correlation Engine 122 and be analyzed by the Cell Site Performance Issue Detection and Correlation Engine 122 according to the algorithm depicted by the example process 300 shown in FIG. 3. In an example embodiment, the system implemented by the Cell Site Performance Issue Detection and Correlation Engine 122 may analyze the logs and determine one or more events has occurred. For example, such events may include, but are not limited to, the RU port(s) of the CSR 108 resetting at 302 (going down and then coming back up), also referred to herein as “flap” or “flapping”; the DU port(s) of the CSR 108 resetting at 304; an error of the precision time protocol (PTP) system of the cell site occurring at 306; and the CSR 108 being not currently reachable at 308.

Each time an RU flap is detected, the system determines at 310 whether all the RU ports went down at the same time (e.g., ports 4 to 9). If all the RU ports did not go down at the same time, then the system checks the interface status of the interfaces to see if they are flapping or down at 312. If the interface status of the interfaces indicates they are flapping or down, then the system may electronically and automatically escalate the performance issue to a field engineering team (“Market”) at 314. If it is determined all the RU ports did go down at the same time, then it is determined at 316 whether the CSR 108 experienced a cold start (e.g., a system power cycle or reboot) at the same time all the RU ports went down. If it is determined that the CSR 108 experienced a cold start at the same time all the RU ports went down (or at substantially the same time all the DU ports went down, an error of the PTP system occurred, or the CSR 108 became not reachable) at 318 then the system may correlate these performance issues to a power issue at the cell site.

In particular, the system may determine a cell site power issue is a cause of the performance issue based on the determination that the CSR 108 experienced a cold restart at substantially the same time as the event occurred. In such a scenario, the system may first determine whether a cellular telecommunication site automation device (e.g., such as SiteBoss® appliances provided by Asentria®) went down or was reset at the same time the CSR 108 experienced a cold restart at 320. This determination may be made manually or automatically. In response to determining the cellular telecommunication site automation device went down or was reset at the same time the CSR 108 experienced a cold restart, the system then determines whether there exists an on-site battery for powering the cell site at 322. This determination may be made manually or automatically. The system may then electronically escalate an issue at 314 regarding cell site power to a field engineering team in instances where it is determined that the cellular telecommunication site automation device went down or was reset at a same time the CSR experienced a cold restart and there exists an on-site battery for powering the cell site (as this should not normally occur if there is such an on-site battery).

In response to determining that a cellular telecommunication site automation device (e.g., a SiteBoss® appliance) did not go down and was not reset at the same time the CSR experienced a cold restart, the system then determines whether a silent reload of the CSR occurred at the same time the CSR experienced a cold restart at 324. This determination may be made manually or automatically. In response to determining that a silent reload of the CSR did not occur at the same time the CSR experienced a cold restart, the system then determines at 326 whether an administrative reload occurred at the same time the CSR experienced a cold restart. This determination may be made manually or automatically. If an administrative reload occurred at the same time the CSR experienced a cold restart the process 300 may end by determining the cause of the cold start of the CSR 108 was the administrative reload (e.g., someone performed a manual reload of the CSR 108).

In response to determining that a silent reload of the CSR did occur at the same time the CSR experienced a cold restart, the system then determines at 328 whether a specific version of software on the CSR router is associated with the silent reload (e.g., a version older than version 7.8.2 for a Cisco CSR). This determination may be made manually or automatically. In instances in which it is determined that the specific version of software on the CSR router is associated with the silent reload, the system may electronically initiate an upgrade of the version of software on the CSR at 330. In instances in which it is determined that the specific version of software on the CSR router is not associated with the silent reload, the system may initiate an investigation regarding the silent reload with a service provider or vendor of the CSR 108 at 332.

Each time DU flap is detected, the system determines whether all the DU ports went down at the same time (e.g., ports 3, 14, 15 and 24) at 334. If all the DU ports did not go down at the same time, then the system checks the interface status of the interfaces to see if they are flapping or down at 336. If the interface status of the interfaces indicates they are flapping or down, then the system may electronically and automatically escalate the performance issue to a field engineering team (“Market”) at 314.

If it is determined all the DU ports did go down at the same time, then it is determined at 316 whether the CSR 108 experienced a cold start (e.g., a system power cycle or reboot) at substantially the same time all the DU ports went down. If it is determined that the CSR 108 did not experience a cold start at substantially the same time all the DU ports went down, then the system may determine at 340 whether the DU is currently reachable. The system may electronically escalate an issue regarding the DU to a radio access network (RAN) engineering team at 342 in instances where it is determined the DU is currently reachable. The system may electronically escalate an issue regarding the DU not currently being reachable to a field engineering team (“Market”) at 314 in instances where it is determined the DU is not currently reachable.

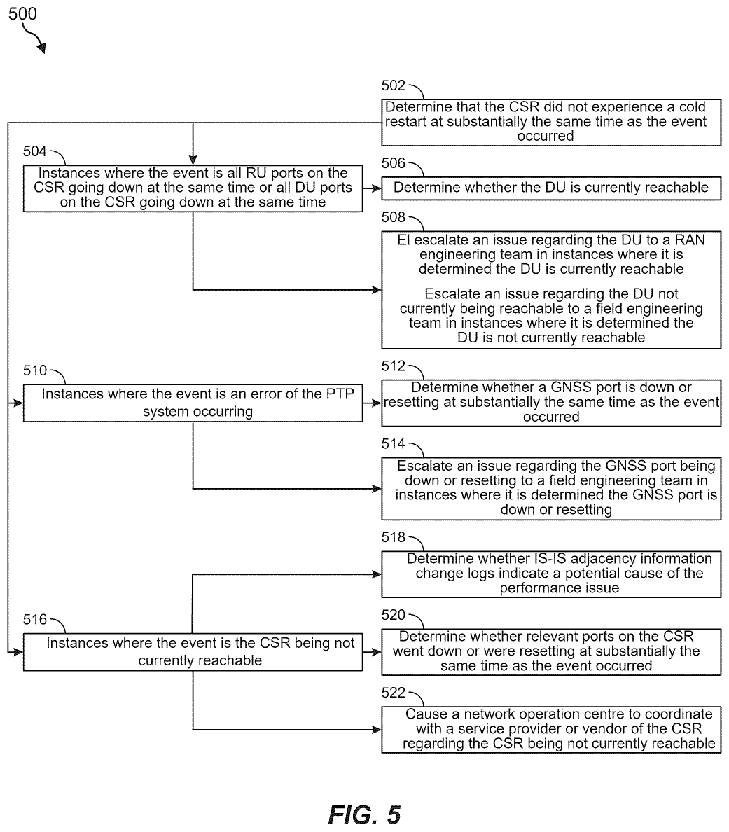

In instances where the system detected an error of the PTP system occurred at 306 or the CSR 108 became not reachable at 308, but the system determined that the CSR 108 did not experience a cold start at substantially the same time as these events, the system may then follow the process applicable to these scenarios shown in the process 500 of FIG. 5.

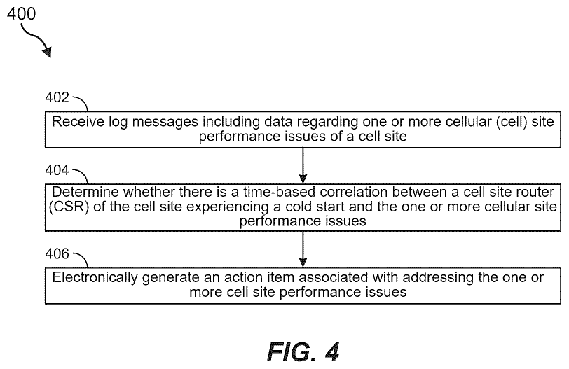

FIG. 4 illustrates a logical flow diagram showing at a higher level than in FIG. 3, one embodiment of example process 400 for cellular site performance issue detection and correlation in accordance with embodiments described herein.

At 402, the system receives log messages including data regarding one or more cellular (cell) site performance issues of a cell site. In an example embodiment, the one or more cell site performance issues may include one or more issues regarding a radio unit (RU) of the cell site, a distributed unit (DU) of the cell site, a precision time protocol (PTP) system of the cell site, and the CSR being not reachable. Data regarding one or more cellular cell site performance issues may include data indicating CSR ports for one or more of the RU and DU going down or resetting.

At 404, the system, based on the log messages, determines whether there is a time-based correlation between a cell site router (CSR) of the cell site experiencing a cold start and the one or more cellular site performance issues. Determining whether there is a time-based correlation between the CSR of the cell site experiencing a cold start and the one or more cell site performance issues may include determining the cell site performance issue based on detecting an event occurring. In an example embodiment, the event may be all RU ports on the CSR going down at a same time; all DU ports on the CSR going down at a same time; an error of the PTP system occurring; or the CSR being not currently reachable.

At 406, the system, based on the determination whether there is a time-based correlation between the CSR experiencing a cold start and the one or more cell site performance issues, electronically generates an action item associated with addressing the one or more cell site performance issues.

FIG. 5 illustrates a logical flow diagram showing one embodiment of example process 500 for cellular site performance issue detection and correlation in instances where the CSR 108 did not experience a cold restart at substantially the same time as a performance event occurred in accordance with embodiments described herein.

At 502, in response to detecting the event occurring, the system determines that the CSR did not experience a cold restart at substantially the same time as the event occurred.

At 504, in instances where the event is all RU ports on the CSR going down at the same time or all DU ports on the CSR going down at the same time, at 506 the system determines whether the DU is currently reachable. Then at 508, the system electronically escalates an issue regarding the DU to a radio access network (RAN) engineering team in instances where it is determined the DU is currently reachable or escalates an issue regarding the DU not currently being reachable to a field engineering team in instances where it is determined the DU is not currently reachable.

At 510, in instances where the event is an error of the PTP system occurring, at 512, the system determines whether a Global Navigation Satellite System (GNSS), for example a global positioning system (GPS), port is down or resetting at substantially the same time as the event occurred. Then at 514, the system escalates an issue regarding the GNSS port being down or resetting to a field engineering team in instances where it is determined the GNSS port is down or resetting

At 516, in instances where the event is the CSR being not currently reachable, at 518 the system determines whether Integrated Intermediate System-to-Intermediate System (IS-IS) adjacency information change logs indicate a potential cause of the performance issue.

At 520, the system determines whether relevant ports on the CSR went down or were resetting at substantially the same time as the event occurred.

At 522, the system electronically causes a network operation center (NOC) to coordinate with a service provider or vendor of the CSR regarding the CSR being not currently reachable based on determining one or more of: the IS-IS adjacency information change logs indicating a potential cause of the performance issue and relevant ports on the CSR having went down or were resetting at substantially the same time as the event occurred.

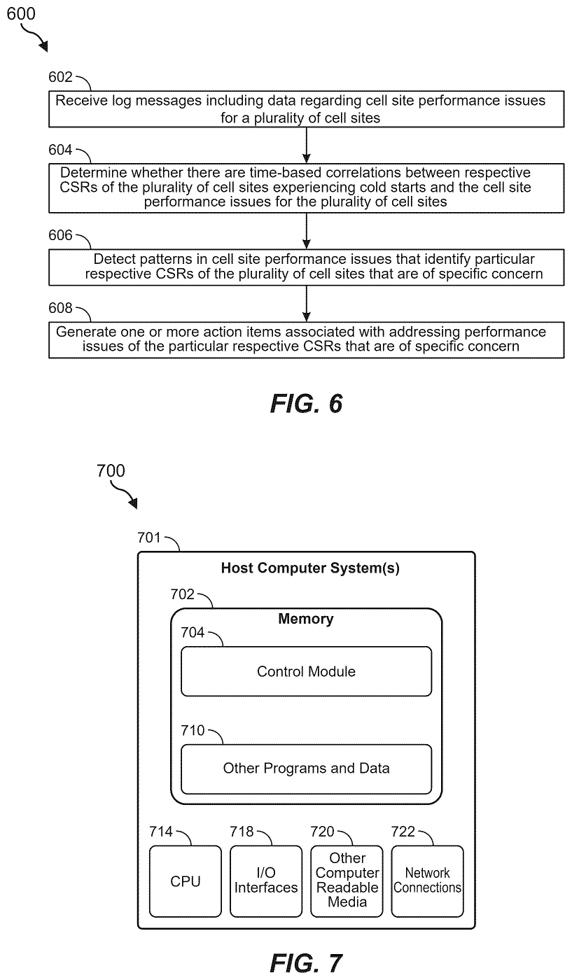

FIG. 6 illustrates a logical flow diagram showing one embodiment of example process 600 for cellular site performance issue detection and correlation involving detecting patterns in cell site performance issues that identify particular CSRs that are of specific concern from a plurality of cell sites in accordance with embodiments described herein.

At 602, the system receives log messages including data regarding one or more cellular (cell) site performance issues for a plurality of cell sites.

At 604, the system, based on the log messages, determines whether there are time-based correlations between respective cell site routers (CSRs) of the plurality of cell sites experiencing cold starts and the one or more cell site performance issues for the plurality of cell sites.

At 606, the system, based on the determination whether there are time-based correlations between respective CSRs of the plurality of cell sites experiencing cold starts and the one or more cellular site performance issues for the plurality of cell sites, detects patterns in cell site performance issues that identify particular respective CSRs of the plurality of cell sites that are of specific concern. For example, these patterns may indicate one CSR has a higher frequency of particular types of performance issues than other CSRs. This particular CSR may then be identified as being of specific concern.

At 608, the system electronically generates one or more action items associated with addressing performance issues of the particular respective CSRs that are of specific concern.

FIG. 7 shows a system diagram that describes an example implementation of underlying computing system(s) 701 for implementing embodiments described herein.

The functionality described herein for cell site performance issue detection and correlation can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 7 illustrates an example of underlying hardware on which such software and functionality may be hosted and/or implemented.

In particular, shown is example host computer system(s) 701. For example, such computer system(s) 701 may represent one or more of those implementing functionality of the cell site performance issue detection and correlation engine 122, and/or those in various data centers, base stations and cell sites shown and/or described herein that are, or that host or implement the functions of: routers, components, microservices, PODs, containers, nodes, node groups, control planes, clusters, virtual machines, NFs, and other aspects described herein for cell site performance issue detection and correlation. In some embodiments, one or more special-purpose computing systems may be used to implement the functionality described herein. Accordingly, various embodiments described herein may be implemented in software, hardware, firmware, or in some combination thereof. Host computer system(s) 701 may include memory 702, one or more central processing units (CPUs) 714, I/O interfaces 718, other computer-readable media 720, and network connections 722.

Memory 702 may include one or more various types of non-volatile and/or volatile storage technologies. Examples of memory 702 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 702 may be utilized to store information, including computer-readable instructions that are utilized by CPU 714 to perform actions, including those of embodiments described herein.

Memory 702 may have stored thereon control module(s) 704. The control module(s) 704 may be configured to implement and/or perform some or all of the functions of the systems, components and modules described herein for cell site performance issue detection and correlation. Memory 702 may also store other programs and data 710, which may include rules, databases, application programming interfaces (APIs), policy and charging rules and data, OSS data, BSS data, software containers, nodes, pods, clusters, node groups, control planes, software defined data centers (SDDCs), microservices, virtualized environments, software platforms, cloud computing service software, network management software, network orchestrator software, one or more network slicing controllers, network functions (NF), artificial intelligence (AI) or machine learning (ML) programs or models to perform the functionality described herein, user interfaces, operating systems, other network management functions, other NFs, etc. Network connections 722 are configured to communicate with other computing devices to facilitate the functionality described herein. In various embodiments, the network connections 722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 518 may include location data interfaces, sensor data interfaces, global positioning system (GPS) interfaces, other data input or output interfaces, or the like. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
at least one memory that stores computer instructions; and
at least one processor that executes the computer instructions to perform actions, the actions including:
receiving log messages including data regarding one or more cellular (cell) site performance issues of a cell site;
based on the log messages, determining whether there is a time-based correlation between a cell site router (CSR) of the cell site experiencing a cold start and the one or more cellular site performance issues; and
based on the determination whether there is a time-based correlation between the CSR experiencing a cold start and the one or more cell site performance issues, electronically generating an action item associated with addressing the one or more cell site performance issues.

2. The system of claim 1 wherein the one or more cell site performance issues includes one or more issues regarding a radio unit (RU) of the cell site, a distributed unit (DU) of the cell site, a precision time protocol (PTP) system of the cell site, and the CSR being not reachable.

3. The system of claim 2 wherein data regarding one or more cellular cell site performance issues includes data indicating CSR ports for one or more of the RU and DU going down or resetting.

4. The system of claim 3 wherein the determining whether there is a time-based correlation between the CSR of the cell site experiencing a cold start and the one or more cell site performance issues includes:
determining the cell site performance issue based on detecting an event occurring, the event being:
all RU ports on the CSR going down at a same time;
all DU ports on the CSR going down at a same time;
an error of the PTP system occurring; or
the CSR being not currently reachable.

5. The system of claim 4 wherein the determining whether there is a time-based correlation between the CSR of the cell site experiencing a cold start and the one or more cell site performance issues further includes:
in response to detecting the event occurring, determining that the CSR did not experience a cold restart at substantially the same time as the event occurred;
in instances where the event is all RU ports on the CSR going down at the same time or all DU ports on the CSR going down at the same time:
determining whether the DU is currently reachable;
in which the action item is electronically escalating an issue regarding the DU to a radio access network (RAN) engineering team in instances where it is determined the DU is currently reachable; and
in which the action item is electronically escalating an issue regarding the DU not currently being reachable to a field engineering team in instances where it is determined the DU is not currently reachable;
in instances where the event is an error of the PTP system occurring:
determining whether a Global Navigation Satellite System (GNSS) port is down or resetting at substantially the same time as the event occurred; and
in which the action item is electronically escalating an issue regarding the GNSS port being down or resetting to a field engineering team in instances where it is determined the GNSS port is down or resetting;
in instances where the event is the CSR being not currently reachable:
determining whether Integrated Intermediate System-to-Intermediate System (IS-IS) adjacency information change logs indicate a potential cause of the performance issue;
determining whether relevant ports on the CSR went down or were resetting at substantially the same time as the event occurred; and
in which the action item is electronically causing a network operation center to coordinate with a service provider or vendor of the CSR regarding the CSR being not currently reachable based on determining one or more of: the IS-IS adjacency information change logs indicating a potential cause of the performance issue and relevant ports on the CSR having went down or were resetting at substantially the same time as the event occurred.

6. The system of claim 4 wherein the determining whether there is a time-based correlation between the CSR of the cell site experiencing a cold start and the one or more cell site performance issues further includes:
in response to detecting the event occurring, determining that the CSR experienced a cold restart at substantially a same time as the event occurred; and
determining a cell site power issue is a cause of the performance issue based on the determination that the CSR experienced a cold restart at substantially a same time as the event occurred.

7. The system of claim 6 wherein the electronically generating an action item associated with addressing the one or more cell site performance issues includes:
determining that a cellular telecommunication site automation device went down or was reset at the same time the CSR experienced a cold restart;
determining whether there exists an on-site battery for powering the cell site; and
electronically escalating an issue regarding cell site power to a field engineering team in instances where it is determined that the cellular telecommunication site automation device went down or was reset at a same time the CSR experienced a cold restart and there exists an on-site battery for powering the cell site.

8. The system of claim 6 wherein the electronically generating an action item associated with addressing the one or more cell site performance issues includes:
determining that a cellular telecommunication site automation device did not go down and was not reset at the same time the CSR experienced a cold restart;
in response to determining that a cellular telecommunication site automation device did not go down and was not reset at the same time the CSR experienced a cold restart, determining that a silent reload of the CSR did not occur at the same time the CSR experienced a cold restart; and
in response to determining that a silent reload of the CSR did not occur at the same time the CSR experienced a cold restart, determining whether an administrative reload occurred at the same time the CSR experienced a cold restart.

9. The system of claim 6 wherein the electronically generating an action item associated with addressing the one or more cell site performance issues includes:
determining that a cellular telecommunication site automation device did not go down and was not reset at the same time the CSR experienced a cold restart;
in response to determining that a cellular telecommunication site automation device did not go down and was not reset at the same time the CSR experienced a cold restart, determining that a silent reload of the CSR occurred at the same time the CSR experienced a cold restart;
in response to determining that a silent reload of the CSR occurred at the same time the CSR experienced a cold restart, determining whether a specific version of software on the CSR router is associated with the silent reload;
in instances in which it is determined that the specific version of software on the CSR router is associated with the silent reload, electronically initiating an upgrade of the version of software on the CSR; and
in instances in which it is determined that the specific version of software on the CSR router is not associated with the silent reload, initiating an investigation regarding the silent reload with a service provider or vendor of the CSR.

10. The system of claim 1 wherein the action further comprise:
receiving log messages including data regarding one or more cellular (cell) site performance issues for a plurality of cell sites;
based on the log messages, determining whether there are time-based correlations between respective cell site routers (CSRs) of the plurality of cell sites experiencing cold starts and the one or more cell site performance issues for the plurality of cell sites;
based on the determination whether there are time-based correlations between respective CSRs of the plurality of cell sites experiencing cold starts and the one or more cellular site performance issues for the plurality of cell sites, detecting patterns in cell site performance issues that identify particular respective CSRs of the plurality of cell sites that are of specific concern; and
electronically generating one or more action items associated with addressing performance issues of the particular respective CSRs that are of specific concern.

11. A method comprising:
receiving log messages including data regarding one or more cellular (cell) site performance issues of a cell site;
based on the log messages, determining whether there is a time-based correlation between a cell site router (CSR) of the cell site experiencing a cold start and the one or more cellular site performance issues; and
based on the determination whether there is a time-based correlation between the CSR experiencing a cold start and the one or more cell site performance issues, electronically generating an action item associated with addressing the one or more cell site performance issues.

12. The method of claim 11 wherein the one or more cell site performance issues includes one or more issues regarding a radio unit (RU) of the cell site, a distributed unit (DU) of the cell site, a precision time protocol (PTP) system of the cell site, and the CSR being not reachable.

13. The method of claim 12 wherein data regarding one or more cellular cell site performance issues includes data indicating CSR ports for one or more of the RU and DU going down or resetting.

14. The method of claim 13 wherein the determining whether there is a time-based correlation between the CSR of the cell site experiencing a cold start and the one or more cell site performance issues includes:
determining the cell site performance issue based on detecting an event occurring, the event being:
all RU ports on the CSR going down at a same time;
all DU ports on the CSR going down at a same time;
an error of the PTP system occurring; or
the CSR being not currently reachable.

15. The method of claim 14 wherein the determining whether there is a time-based correlation between the CSR of the cell site experiencing a cold start and the one or more cell site performance issues further includes:
in response to detecting the event occurring, determining that the CSR did not experience a cold restart at substantially the same time as the event occurred;
in instances where the event is all RU ports on the CSR going down at the same time or all DU ports on the CSR going down at the same time:
determining whether the DU is currently reachable;
in which the action item is electronically escalating an issue regarding the DU to a radio access network (RAN) engineering team in instances where it is determined the DU is currently reachable; and
in which the action item is electronically escalating an issue regarding the DU not currently being reachable to a field engineering team in instances where it is determined the DU is not currently reachable;
in instances where the event is an error of the PTP system occurring:
determining whether a Global Navigation Satellite System (GNSS) port is down or resetting at substantially the same time as the event occurred; and
in which the action item is electronically escalating an issue regarding the GNSS port being down or resetting to a field engineering team in instances where it is determined the GNSS port is down or resetting;
in instances where the event is the CSR being not currently reachable:
determining whether Integrated Intermediate System-to-Intermediate System (IS-IS) adjacency information change logs indicate a potential cause of the performance issue;
determining whether relevant ports on the CSR went down or were resetting at substantially the same time as the event occurred; and
in which the action item is electronically causing a network operation center to coordinate with a service provider or vendor of the CSR regarding the CSR being not currently reachable based on determining one or more of: the IS-IS adjacency information change logs indicating a potential cause of the performance issue and relevant ports on the CSR having went down or were resetting at substantially the same time as the event occurred.

16. The method of claim 14 wherein the determining whether there is a time-based correlation between the CSR of the cell site experiencing a cold start and the one or more cell site performance issues further includes:
in response to detecting the event occurring, determining that the CSR experienced a cold restart at substantially a same time as the event occurred; and
determining a cell site power issue is a cause of the performance issue based on the determination that the CSR experienced a cold restart at substantially a same time as the event occurred.

17. The method of claim 16 wherein the electronically generating an action item associated with addressing the one or more cell site performance issues includes:
determining that a cellular telecommunication site automation device went down or was reset at the same time the CSR experienced a cold restart;
determining whether there exists an on-site battery for powering the cell site; and
electronically escalating an issue regarding cell site power to a field engineering team in instances where it is determined that the cellular telecommunication site automation device went down or was reset at a same time the CSR experienced a cold restart and there exists an on-site battery for powering the cell site.

18. The method of claim 16 wherein the electronically generating an action item associated with addressing the one or more cell site performance issues includes:
determining that a cellular telecommunication site automation device did not go down and was not reset at the same time the CSR experienced a cold restart;
in response to determining that a cellular telecommunication site automation device did not go down and was not reset at the same time the CSR experienced a cold restart, determining that a silent reload of the CSR did not occur at the same time the CSR experienced a cold restart; and
in response to determining that a silent reload of the CSR did not occur at the same time the CSR experienced a cold restart, determining whether an administrative reload occurred at the same time the CSR experienced a cold restart.

19. A non-transitory computer-readable storage medium having computer-executable instructions stored thereon that, when executed by at least one processor, cause the at least one processor to perform operations including:
receiving log messages including data regarding one or more cellular (cell) site performance issues of a cell site;
based on the log messages, determining whether there is a time-based correlation between a cell site router (CSR) of the cell site experiencing a cold start and the one or more cellular site performance issues; and
based on the determination whether there is a time-based correlation between the CSR experiencing a cold start and the one or more cell site performance issues, electronically generating an action item associated with addressing the one or more cell site performance issues.

20. The non-transitory computer-readable storage medium of claim 19 wherein the one or more cell site performance issues includes one or more issues regarding a radio unit (RU) of the cell site, a distributed unit (DU) of the cell site, a precision time protocol (PTP) system of the cell site, and the CSR being not reachable.
